(19) United States
(12) Patent Application Publication
(10) Pub. No.: US 2004/0064415 A1
(43) Pub. Date: Apr. 1, 2004

(54) Personal authentication software and systems for travel privilege assignation and verification

(76) Inventors: David S. Abdallah, Charlottesville, VA (US); Barry W. Johnson, Charlottesville, VA (US); Kristen R. Olvera, Charlottesville, VA (US); Jonathan A. Tillack, Charlottesville, VA (US)

Correspondence Address: WILLIAMS MULLEN, 1 OLD OYSTER POINT ROAD, SUITE 210, NEWPORT NEWS, VA, 23602, US

(21) Appl. No.: 10/618,951

(22) Filed: Jul. 14, 2003

Related U.S. Application Data
(60) Provisional application No. 60/395,361, filed on Jul. 12, 2002.
(60) Provisional application No. 60/474,750, filed on May 30, 2003.

(51) Int. Cl. G06F 17/60

(52) U.S. Cl. 705/50

(57) ABSTRACT

A system for authenticating individuals traveling to and from various destinations at various times. Personal identity and travel privilege verification are coordinated for several modes of transportation, including aircraft, boats, buses, cars and trains. Travel privileges are considered to be the ability to leave the current location, travel to the desired location, travel at specific times, and use specific forms of transportation. The system specifically provides operator privilege verification, allowing individuals to receive vehicle operator privileges. These privileges are evaluated upon the individual's application, and are periodically updated at the discretion of the controlling institution. The system provides for verification of vehicle operator privileges while the vehicle is in transit, and an apparatus for docking the secure authentication apparatus within the vehicle.

### RELATED U.S. APPLICATION DATA

This application claims priority under USC 119(e) of provisional patent application Serial No. 60/395,361 filed on Jul. 12, 2002 entitled, “Driver and Vehicle Authentication and Auditing Apparatus, Method and System for Interfacing with a Vehicle Transponder,” and provisional patent application Serial No. 60/474,750 entitled, “Secure Biometric Identification Devices and Systems for Various Applications,” all of which are hereby incorporated by reference in their entireties.

### BACKGROUND OF THE INVENTION

1. Field of the Invention

This invention relates generally to the field of information security, and more particularly to the authentication and verification of individuals desiring to travel using various modes of transportation.

2. Necessity of the Invention:

Travel privileges are granted on the ability of an individual to present acceptable credentials. These credentials typically include passports and driver's licenses, and are frequently based on observation of an individual's identification card with an accompanying picture and comparison of that picture with the face of the alleged card owner. For example, a state-issued driver's license or a national government-issued passport that contains the person's name, country of citizenship, birth date and location, and a photograph typically identifies would-be American flyers. These paper-based identity credentials have major flaws that can jeopardize travel security. Because travelers of other nationalities may not use a driver's license, and because obtaining a driver's license is easier and comes with fewer restrictions than a passport, this discussion centers predominantly on the flaws of the passport.

The passport is typically shown at check-in and/or application for a boarding pass, at gate checkpoints, and upon entering a country, although this varies depending on national or regional laws. The passport comprises a bound paper booklet and ranges in color and size dependent on the issuing country. All passports contain the passport holder's name, nationality, birth date and photograph (headshot only) on one inside cover. The pages of the passport are stamped with entry and exit visas upon entering and exiting a country, but this again varies according to local code. For example, citizens of European Community (EC) countries are not always required to present their passport upon entrance to an EC country, even if it is not their country of citizenship, and so their passports will not reflect intra-EC travel. The United States is somewhat more stringent and requires all persons entering the country via aircraft to present a passport.

Obtaining a passport as an American citizen is as simple as visiting a Passport Agency and providing credentials, which can be easily forged. The Passport Agency requests a previously-issued passport or birth certificate for authentication, but if these documents are unavailable an applicant must provide a Letter of No Record—issued by the applicant's state of residence, with name, date of birth, years that were searched for a birth record and record that there is no birth certificate on file for the applicant—and any of a family bible record, baptismal certificate, doctor's post-natal examination records, census records, hospital birth certificate, or early school record. In the event that none of those are available, the applicant may submit an Affidavit of Birth, in which a blood relative such as an aunt or uncle vouches for the applicant's birth date. This lackadaisical system makes it possible for anyone to apply and successfully acquire a passport with false credentials. Furthermore, the simple nature of the passport makes it easy to construct a false passport for anyone with skill in printing and forgery.

For travelers departing the United States, the passport is customarily shown for personal authentication at check-in before a passenger boards an aircraft. The individual goes to the ticketing counter of the airline from whom he has purchased a seat and shows his ticket and passport to the airline agent. The airline agent enters information from the passport into a computer system that performs cursory background checks on the person. The airline agent also performs visual verification that the person shown on the passport is the person standing before him. If the passenger is verified as the possessor of the passport—and has paid for a seat—he is cleared to travel and provided with a boarding pass. The boarding pass is simply a card that has the passenger's name and flight details printed. In order to board the plane, the individual must supply the boarding pass—which could have been stolen or altered any time by a sophisticated criminal between authentication at the ticket counter and travel to the gate—and his passport once again. The same type of visual verification is performed.

Travelers entering the United States must present their passport at the Immigration counter. The individual's name is entered into a computer system that verifies that the individual came from a recently arrived flight and that the individual's name is not on any warning lists from the FBI, INS, etc. The Immigration agent also performs a visual verification that the person on the photograph is the person who provided the passport. If the individual clears these two checks, the agent stamps the booklet with the date and port-of-entry (airport), and the individual is free to enter the United States. There is no verification that the person is a citizen of the country from whence the passport was issued, or even that the person is actually who he claims to be other than the visual verification.

In this highly technological era, papers are easy to forge, and a passport does not pose a substantial hurdle to a sophisticated criminal with a computer. Changing a passport picture is as simple as removing the laminating material covering the photograph and inserting a new picture.

Many proposed solutions that allow for improved personal identification require an individual to submit highly private data to the government, resulting in a compromise of personal privacy. This data was typically the SSN, but in recent years biometric characteristics have become a popular way to authenticate persons because they are much harder to forge. Similarly to the SSN based-system, many implementations of biometric authentication systems require an individual to submit the characteristic to a government-controlled, centralized database. This raises several rational concerns about “big brother”, identity theft, lack of personal privacy, and general discomfort among potential users. Additionally, proposed solutions to identity credential verification often include the use of magnetic stripe cards, proximity cards, PIN numbers and smart cards. Each of these solutions has security flaws, but equally importantly, these systems are not accessible to all individuals. Those with physical disabilities may not be able to reach a magnetic stripe reader or may not be able to punch in a PIN number.

Furthermore, these types of identification are not typically expandable to cover multiple modes of transportation, privilege types and levels, and situations. The passport is typically only used for international aircraft travel, while the driver's license can be used to authenticate during domestic aircraft travel or to demonstrate driver privileges.

3. Description of the Related Art

Air Travel Related Art

Several patents describe systems for improving travel that use electronic devices. In one such patent, U.S. Pat. No. 6,101,477, Hohle describes a smart card system, apparatus and methods for improving travel efficiency. The apparatus of the invention is a smart card to which the user downloads airline, hotel, rental car and other payment-related applications. These vendors may also download vendor-specific applications to the device. The apparatus additionally comprises security features allowing the vendors to create custom and secure file structures; however, two eight-byte cardholder verification numbers that serve as a PIN number provide the security. The PIN or password security scheme is insecure due to the possibility of its compromise. Hohle provides no way to definitively prevent unauthorized users from accessing the apparatus. Furthermore, Hohle does not propose using the apparatus to serve as a form of identification, such as a passport. Also, Hohle does not address privacy issues.

Mann, in U.S. Pat. No. 6,119,096 describes a system for airline ticketing, purchasing, check-in and boarding that uses biometric technology for authenticating individuals to the system. The claims of the patent discuss only iris pattern recognition methods, while the specification notes that the biometric may be one of many different types including DNA, fingerprints, etc. The individual's biometric template is stored in encrypted form along with account information in a centralized database. When the individual desires to perform a transaction, such as boarding the aircraft, he submits his current biometric template via a template capture station at the gate. The template is then encrypted and verified against the encrypted template stored in the database, and the database returns an authorization or denial. Mann's invention does not protect the privacy of the individual's template, as it is stored in a centralized database. Furthermore, Mann does not provide or anticipate a device facility suitable for additional operational flexibility, such as accessing multiple travel applications and privilege levels.

Sweatte, in U.S. Pat. No. 6,135,688, describes a method and system for airport security using biometric data and a wireless smart card. Upon check-in a traveler must undergo identification by means of a fingerprint or retinal scan, provide a government issue ID card, such as a driver's license, and have his photograph taken. This information is verified against law enforcement databases and if the verifications return positively the traveler is supplied with a wireless smart card. The traveler is required to carry this smart card for the duration of travel within the airport and on-board the airplane, and it is used to track the individual's journey. However, the smart card is not tied to the individual by anything other than the issuing process; Therefore, an individual's card could be lost, stolen, discarded, or illegally transferred to another individual. The Sweatte patent does not address privacy issues or multiple different travel privileges.

Driver's License Related Art

The cognitive system for a vehicle and its occupants, as depicted by Gehlot in U.S. Pat. No. 6,310,242, receives, processes, and stores real-time data gathered from the electronic subsystems of a motor vehicle. It also includes a data collection method for validating and authorizing an individual to the vehicle, thus restricting operators to an approved subset. This data assembly is performed by gathering biometric information from the driver and reading the information from a user-supplied ‘vehicle information card’. The known credentials are stored within memory located in the vehicle and do not require a centralized database. However, as described in the patent, the system has a wireless link to the Department of Transportation and the Division of Motor Vehicles (“DMV”) in order to report additional information to these agencies. Gehlot does not, however, detail how these credentials are initially verified and validated, and therefore cannot guarantee that the information enrolled in the car's memory is accurate. The Gehlot invention also does not prevent the information in the vehicle information card from being altered after issuance.

U.S. Pat. No. 5,519,260 to Washington discloses a driver's license-driven system for use with an automotive vehicle having a normally disabled ignition system, which professes to simplify access to vehicles and improve vehicle security while ensuring only authorized drivers access vehicles equipped with Washington's invention. The driver's license of the invention for authenticating drivers to vehicles is encoded with identity credentials of the prospective driver, using technology such as a magnetic strip. This driver's license is inserted into a reader container in the vehicle that generates an identification signal representing the presumed identity of the submitter of the driver's license. A microprocessor compares the identification signal from the driver's license with the stored data representing authorized driver(s) for the vehicle. When the driver's license identification signal matches the stored data in memory, the microprocessor generates an output signal that enables the vehicle ignition system. Alternatively, when the driver's license identification signal does not match the stored data, a radio transmitter transmits the driver's license identification signal to a central station that compares this signal against stored data representative of different drivers. If a match is obtained, the central station generates a radio signal back to a radio receiver in the vehicle that is read by the microprocessor, and the microprocessor then generates an output signal that enables the ignition system. Alternatively, a timer is employed to allow operation of the vehicle only during prescribed time-periods, depending on the operator.

In a further version, the system includes a radio receiver that receives a radio signal from a transmitter on an ankle bracelet worn by a person with a restricted driver's license. Once the receiver detects the radio signal from the bracelet, a microprocessor compares the current time with a time schedule containing time-periods during which operation of the vehicle by the prospective driver is unauthorized. In the event that operation of the vehicle is unauthorized, the microprocessor generates a disabled signal that disables operation of the vehicle. While the patent discloses a product that appears to be utilitarian for applications where the submitter of the driver's license is “always trusted”, in reality, it would be relatively easy to spoof or thwart such a system, simply by obtaining either the actual license or a forged license that is ostensibly registered to an authorized driver. While this invention is a driver's license-initiated and driver's license-driven application, it is, per se, not a driver's license application. Further, some of the ostensible authentication functions of the driver's license reader in the automobile that require a central site interface could also provide exposure to packet sniffing and eavesdropping, with subsequent compromise of the driver's license holder's personal privacy. This product, in some circumstances, can actually expose the unwary driver's license user to jeopardy of identity theft.

U.S. Pat. No. 4,982,072 to Takigami discloses a driver's license being “IC-carded”, wherein information stored in the driver's license card is read out to detect matched or mismatched relations with a driver's license number set beforehand. According to the invention, operator license penalty point data are stored on the card, tickets and violation data are stored on the card, and permissions and prohibitions on starting an engine are stored on the card. Information stored on the driver's license card is updated by means of a keyboard. Other versions of the invention are provided, wherein a driver's license card controller is installed in a DMV office or other offices administrating driver's license, allowing quick updates, renewals, and alterations of driver's licenses. While there are definite advantages to such a system, it is apparent that thwarting or spoofing the system can be readily accomplished by a sophisticated imposter. There are no guarantees that the submitter of the driver's license is in fact who he says he is. Furthermore, there are no privacy accommodations in the Takigami invention.

Transponder Related Art

In U.S. Pat. No. 4,738,134, Weishaupt teaches a security installation for motor vehicles that uses a stationary transponder attached to the vehicle and a portable transponder that is carried by a potential driver. The stationary transponder transmits a coded signal to the portable transponder; upon receipt of the coded signal the portable transponder transmits a coded response signal. If the stationary transponder receives a signal that it expects, it creates an unlocking signal to send to the vehicle's unlocking system. This system does not require that the potential driver authenticate himself to the portable transponder, so the driver of the vehicle cannot be identified.

In U.S. Pat. No. 5,736,935, Lambropoulos illustrates a similar keyless vehicle entry and engine starting system that again uses a local and remote transceiver. Each remote transceiver stores a unique security code, and the local transceiver stores the security codes representative of the remote transceivers that may validly gain entry to the vehicle. If a remote transceiver sends its security code, and the code matches one stored in the local database, the engine may start. Neither of these inventions incorporates a method for communication to a centralized location, nor do they associate the remote transceiver with a particular individual. These patents seem to describe devices similar to the current keyless-entry systems installed in new vehicles. There are several other patents in this vein.

Similarly to a home security system, Higdon's system and methods for triggering and transmitting vehicle alarms to a central monitoring station, as described in U.S. Pat. No. 5,874,889, use a security code and keypad to disengage an alarm system. If the user types in the correct security code, a starter-blocking relay is disengaged, and the user may start the car. However, if the code is not entered before the user turns the ignition switch to the “on” position, the vehicle will silently start a timer, and if the code is not entered before the timer expires, the vehicle will wirelessly, and silently, transmit an alarm signal to a central station. The security of this system is completely overridden by a compromise of the security code. Furthermore, it does not allow the system to distinguish between users for auditing purposes.

Washington, in U.S. Pat. No 5,519,260 illustrates a vehicle security system in which a driver's license is encoded with information in a format such as a magnetic strip. The card is inserted into a reader in the car and the information is read from the card. If the data matches data stored in a local cache in the car, the vehicle ignition system is authorized to start. If the data is not located within the cache, the vehicle uses a wireless transponder to communicate with a central station storing many users' information. If the data is located within the central station, again the vehicle ignition system is authorized to start. While the invention appears useful for some applications, there is no provision for ongoing checks to confirm the person who was initially verified and permitted to start the vehicle is in fact the person who continues to operate it. Further, there is no provision of or sensitivity to driver privacy.

U.S. Pat. No. 6,352,045 to Takashima teaches an immobilization system for an engine of a watercraft, comprising: a transponder security code, a communication device configured to receive a security code from the transponder without direct electrical connection between the two, and an engine control means for preventing the operation of the engine if the security code received by the communication device does not match a predetermined authorized security code. There is no mention or provision of privacy features in this invention.

In U.S. Pat. No. 6,323,761, Son describes a vehicular security access system that uses optical recognition to identify persons authorized to unlock a vehicle. An iris image pattern is enrolled and stored within a database in the vehicle. When an individual desires to unlock the doors or trunk, he grasps the handle of the door. This causes the interior lights to come on and a camera to turn towards the individual. This camera will capture the iris image of the individual and compare it to the stored database. If the iris image matches one stored in the database, the door unlocks; otherwise an alarm sounds. This system also has a keypad/security code combination in the event that the camera or computer system fails. Because this system uses a biometric characteristic to identify the individual, it is far more secure and precise than the systems described above. However, it does not describe any methods for using a wireless transponder to access databases other than the one stored locally in the car. Additionally, the system illustrated requires significant ancillary equipment to be deployed within the vehicle, and further requires the driver to orient himself directly in the line of sight of a self-positioning iris-reading camera.

In U.S. Pat. No. 6,400,042, Winner describes an anti-theft system in which the operator carries a personal identification unit (PIU) that communicates with a vehicle control unit (VCU) within the vehicle. The VCU has two modes; one mode allows operation of the vehicle while the second mode inhibits operation of the vehicle. When the PIU comes within range of the VCU, the two exchange information and data to determine whether the individual is an authorized operator. If he is, the VCU will switch modes to allow operation of the vehicle. When the PIU leaves range of the vehicle control unit, the VCU again switches modes to inhibit operation of the vehicle. This system is not flexible, nor does it incorporate biometric technology.

Biometric Personal Identification Device Related Art

Russell, in U.S. Pat. Nos. 5,481,265, 5,729,220, 6,201,484, and 6,441,770 describes a ‘secure access transceiver.’ The invention illustrates a hand-held electronic device that incorporates wireless technology with a button-oriented user interface. The device is used to provide both identification of an individual and a device to a receiving device or system.

Russell, Johnson, Petka and Singer, in U.S. application Ser. No. 10/148,512, describe a Biometric Personal Identification Device (BPID). A BPID is a hand-held electronic device that provides multi-factor authentication and allows its enrolled operator to control the release and dissemination of stored information such as financial accounts, medical records, passwords, personal identification numbers, and other sensitive data and information. The device has tamper-resistant packaging with form factors ranging from credit card size to key fobs. Various embodiments also include a biometric scanner, a liquid crystal display (LCD) and buttons for user interaction, and a wireless interface for communication with other electronic devices. The device has been developed so that the fingerprint cannot be physically or electronically removed or transmitted from the device, and information cannot be physically or electronically removed or transmitted from the device unless released by the operator of the authorizing biometric. All data and processing is performed securely. The BPID can store a variety of data and applications, though it is primarily intended for point-of-sale or other financial transactions. However, the BPID does not describe methods for travel identification or other travel-related functions.

### BRIEF SUMMARY OF THE INVENTION

The invention disclosed herein provides a complete system for authenticating individuals traveling to and from various destinations at various times. The invention coordinates personal identity credential verification for several modes of transportation, including aircraft, boats, buses, cars and trains using a personal identification device. Individuals' assigned travel privileges are combined into a centrally controlled database. Travel privileges are considered to be the ability to leave the current location, ability to travel to the desired location, ability to travel at specific times, and ability to use specific forms of transportation. These privileges are evaluated upon the individual's application, and are periodically updated at the discretion of a governing institution.

The invention also includes vehicle operator privilege verification as a subset of travel privileges, allowing individuals to receive vehicle operator privileges for various modes of transportation, destinations, and times. The invention discloses methods for providing vehicle operator privileges while the vehicle is in transit, and further provides an apparatus for docking the personal identification device within the vehicle.

### BRIEF DESCRIPTION OF DRAWINGS

Master Reference Numeral List

FIG. 1: Credential verification

100 Personal identification device

132 Department of Criminal Justice database

133 NAPHSIS database

134 SSN database

135 INS database

136 Other database

137 Name, public key and privileges database

FIG. 2: Sample database of names, public keys and privileges

FIG. 3: Architecture of the travel application

342 Travel privilege certificate storage space

343 Audit log storage space

347 Travel privilege certificate receipt function

348 Travel privilege certificate transmission function

349 Audit log transmission function

FIG. 4: Components of the travel privilege certificate

471 Traveler's name

472 Certificate issue date

473 Certificate expiration date

474 Certificate serial number

475 Privilege type

476 Privilege date and time

477 Mode of transportation

478 Destination

479 Other

FIG. 5: Receiving and using travel privilege certificates in an airline example

501 Request ticket

502 Consult travel-governor's database for privileges

503 Individual possesses appropriate privileges?

504 Issue travel privilege certificate ticket

505 Present travel privilege certificate ticket

506 Ticket is valid?

507 Issue travel privilege certificate boarding pass

508 Present travel privilege certificate boarding pass

509 Boarding pass is valid?

510 Permit access to gate

511 Quit

FIG. 6: Docking apparatus

601 Data jack connector

602 Power jack connector

603 Cradle

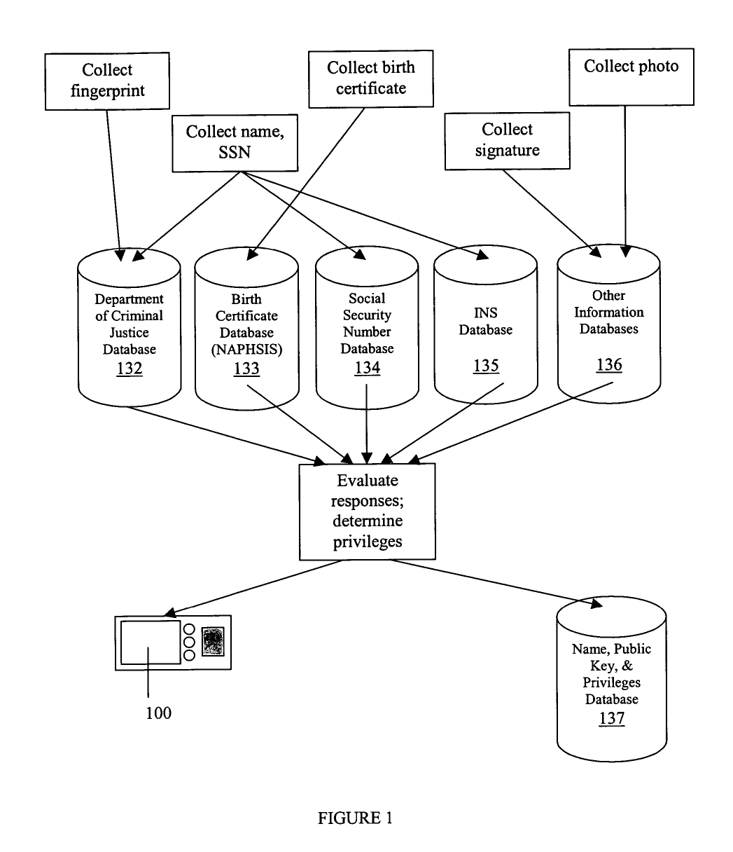

FIG. 1 illustrates the credential verification process before an individual is authorized to receive a travel application.

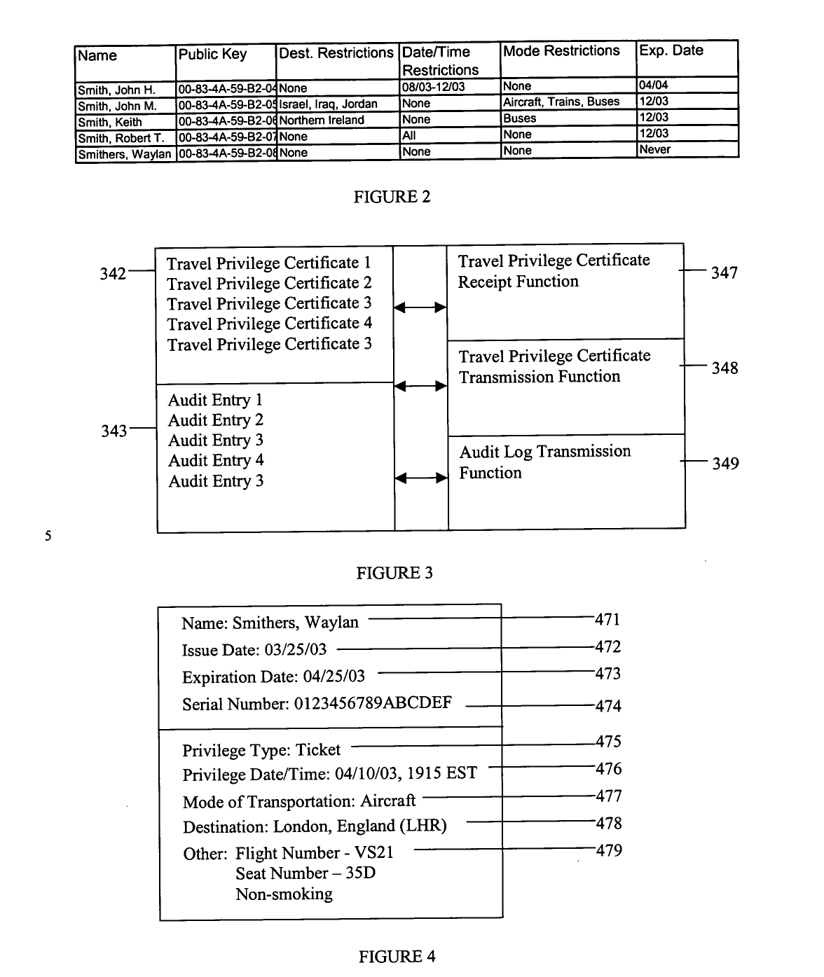

FIG. 2 illustrates a sample database of individuals' names, public keys, and associated travel privileges.

FIG. 3 illustrates the architecture of the travel application.

FIG. 4 illustrates the components of a travel privilege certificate.

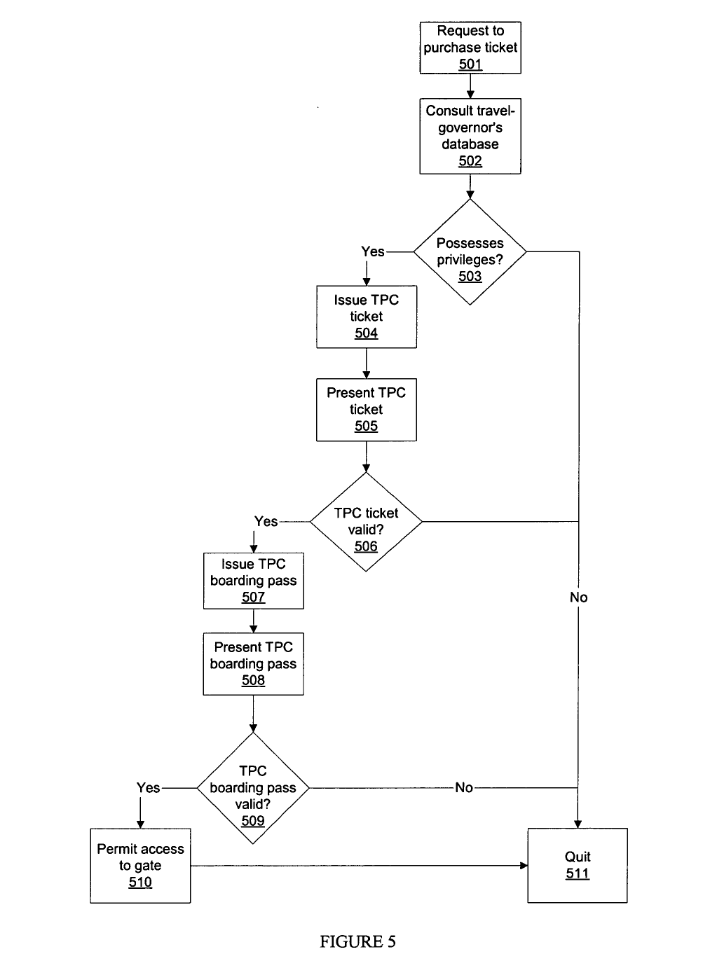

FIG. 5 illustrates a process for receiving and using travel privilege certificates using a traditional airline application.

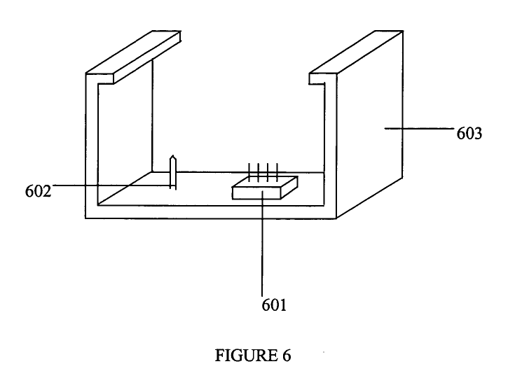

FIG. 6 illustrates the docking apparatus.

### DETAILED DESCRIPTION OF THE INVENTION

Travel System

The travel identification system described herein makes use of a personal identification device. A personal identification device is any handheld device that provides means for identification of its authorized owner and storage for travel privileges. This may range from a biometrically enabled handheld computer or PDA to a smart card. In the preferred embodiment of the invention, the personal identification device is described in U.S. patent application Ser. No. 10/148,512, and will be used hereafter for explanation. BPIDs typically are issued to individuals by a device-governing institution, and because the device can run and store multiple applications, an individual may have already received a device before requesting travel permissions. Travel permissions are monitored by a travel-governing institution, which may be part of the government or an independent agency. The travel-governing institution is responsible for verifying an applicant's credentials with a variety of sources, determining the individual's appropriate travel privileges, and downloading the travel privileges on to the individual's BPID. It may further be responsible for enrolling the individual and an associated biometric into the device, and issuing a digital certificate, containing an asymmetric key pair, to the individual. The travel-governing institution may choose to use this digital certificate as its official verification of an individual's identity, or may wish to use its own certificate. The travel-governing institution is further responsible for retaining a public key, travel permissions, and name for each individual in a database. This database is updated at the discretion of the travel-governing institution to reflect changes in individuals' permissions. The types of travel permissions are discussed in further detail below.

Acquisition of Travel Privileges

Verification of Personal Identity

As seen in FIG. 1, individuals must submit several pieces of personal information to the travel-governing institution before they receive travel-related privileges. This data includes “standard information” such as name, date of birth, SSN, and a birth certificate or Letter of No Record. The information also includes a photograph of the applicant's face, a digital representation of the applicant's handwritten signature, and a fingerprint, or other biometric characteristic. The travel-governing institution submits this information to five distinct databases to ascertain the individual's background.

The first database is the Federal Department of Criminal Justice 132, which enables the agent to initiate and complete a criminal background check. The agent can view the individual's crime record and evaluate the individual as a candidate for the credential. For example, an individual frequently arrested for disrupting flights or other distracting behavior may be prevented from obtaining aircraft flight privileges. Alternatively, his BPID 100 may receive special notations that briefly outline the individual's history.

The second database is the birth certificate database 133 planned by the National Association of Public Health Services Information System (NAPHSIS), which provides electronic files of all the United States'-issued birth certificates. This allows the agent to validate a presented birth certificate. The agent also accesses the SSN database 134, enabling the agent to verify the validity of the provided SSN.

The agent then accesses the Immigration and Naturalization Service (INS) database 135, allowing the agent to verify the national status of the individual. The fifth database 136 is established by the travel-governing institution, and it stores digital photographs captured by agents during the verification process. The database is intended to allow agents to crosscheck the new photograph with those of existing travel privilege-holders, preventing a person from obtaining multiple certificates with potentially different names.

Assignment of Privileges

Upon verification of the individual's credentials, the travel-governing institution determines the level of privileges to be assigned. The travel-governing institution creates a certificate for the individual and assigns an associated asymmetric key pair to the individual. This certificate is signed by the travel-governing institution and can be accepted as a legitimate credential. The travel-governing institution maintains a database 137 of verified individuals' names and their associated public keys. As described above, this certificate can be applied as the digital enrollment certificate described above and downloaded to the BPID 100, or may be used as a proprietary certificate for the travel-governing application.

The database also stores the assigned privilege levels; a sample database can be seen in FIG. 4. There are four specific privileges that are assigned for the preferred embodiment: destinations, dates/times, modes of transportation, and date of validity or expiration date. The first privilege, destinations, establishes where the individual may travel. The second privilege, dates/times, establishes when the individual may travel. For example, an individual convicted of a minor crime may have a date range that is limited to times after the termination of a jail sentence. The third privilege, modes of transportation, establishes what types of vehicle the individual may use for travel. This field is intended to specify the modes of transportation on which an individual may ride, and may include cars, buses, trains, aircraft, and ships. The fourth privilege is a date of validity, which simply signifies when the credentials are no longer accepted and must be re-verified by the travel-governing institution.

This database 137 may be merged with the database of names and photographs 136 as the travel-governing institution deems necessary. Additionally, the database 137 may incorporate stored biometrics as the travel-governing institution requires; however, this may result in a compromise of some of the privacy concerns of the invention.

Assignment and Use of the Travel Application

The travel-governing institution is responsible for downloading its associated software onto an individual's BPID 100 after verification of identity. The travel application, as it is hereafter called, can be seen in FIG. 5 and comprises three different functions and two distinct variables.

Individuals will typically want to use the travel application to perform a travel-related action, and will request privileges from an institution. This institution may be the travel-governing institution, a vendor, or some other interested party. The travel-related action is typically a request for a ticket/reservation for travel, a boarding pass, port-of-entry privileges, or vehicle operator privileges. The institution will request that the individual provide authentication; once assured of the individual's authentication to the BPID 100 and corresponding ownership of a private key, the institution then consults the travel-governor's database 137 to verify that the individual has the correct privileges to satisfy the request. The institution may also wish to perform institution-specific verifications at this point. When all verification has been completed to the satisfaction of the institution, it creates a travel privilege certificate incorporating the authorization.

The components of the travel privilege certificate can be seen in FIG. 6, and typically consist of the date and time of travel 376, the mode of transportation 377, the privilege type 375, an issue date 372 and expiration date 373, a serial number 374, destination 378, and other pertinent details 379. For example, upon receipt of an airline ticket purchase request, an airline or vendor would verify that the individual has aircraft travel privileges for the requested date and time. If so, the vendor creates a travel privilege certificate with the mode of transportation 377 set to ‘aircraft’, the type of privilege 375 set to ‘ticket’, and the date and time 376 as per the individual's request. The expiration date 373 simply sets a date when the certificate is no longer valid, and the serial number 374 allows the certificate to be uniquely identified. The travel privilege certificate is additionally signed, either by the travel-governor or the issuing institution, for future verification. The first function of the travel application 247 preferably allows the BPID 100 to receive these travel privilege certificates and have the application store them.

The second function of the travel application 248 preferably allows an individual to present stored travel privilege certificates to other devices and individuals. The individual may present all travel privilege certificates in one batch, or may search his device for all certificates with a particular date/time range, mode of transportation, type of privilege, or expiration date. Alternatively, the individual may search for a certificate's serial number. This function can be configured to require user authentication before transmission of the travel privilege certificate. For example, the travel privilege certificate can only be sent if the individual has run the authentication function no longer than five minutes prior. This can be established at the discretion of the travel-governing institution.

The third function of the travel application 249 preferably allows the enrolled individual to present an application audit log. As events occur in the application, such as travel privilege certificate receipt, the application records the event and associated data, such as date and time, within an audit log section 243 of storage. These records can be periodically downloaded to other devices as per the device-governing institution, travel-governing institution, or individual's desire.

Authenticating with the Travel Application

As seen in FIG. 5, an individual possessing travel privileges to fly to Europe has requested 501 to purchase a ticket to fly to London, England, in the method described above. The ticket vendor consults 502 the travel-governor's database 137 and verifies 503 that the individual has privileges allowing him to fly and allowing him to travel to London on his requested dates. Noting that this trip is permissible, the ticket vendor issues 504 a travel privilege certificate ticket to the individual. The individual now uses the first function of the travel application to download the travel privilege certificate ticket to his BPID 100.

On the day of the requested travel the individual travels to the airport, where he uses the second function of the travel application to present 505 the travel privilege certificate ticket at check-in as according to rules established by the airport. If the airline determines that the travel privilege certificate ticket is valid 506, the individual receives 507 a travel privilege certificate boarding pass. When he goes to the aircraft gate, he uses the second function of the travel application to present 508 the travel privilege certificate boarding pass. A turnstile or other barrier equipped with means for receiving and processing certificates from the BPID receives the travel privilege certificate boarding pass and validates 509 it. Because the certificate is self-contained, and is trusted because of its digital signature, the barrier can now allow 510 the individual to have access to the gate and allow him to board the aircraft without re-verifying privileges against the database 137. The travel application now terminates 511. Note that the application also terminates 511 if a certificate does not validate correctly or the individual does not possess appropriate privilege levels to perform the requested action.

This operation may be automatic and require no authentication from the individual, or it may require authentication. These rules may be established at the discretion of the travel-governing institution or other institutions as necessary. Clearly, using biometric authentication provides a greater level of security in the system.

Vehicle Operator Privileges

One notable subset of travel privileges allows individuals to operate vehicles. Individuals without prior permissions to travel should not—and cannot—operate vehicles, as traveling is an inherent part of vehicle operation. For example, an individual with privileges to travel to Mexico may wish to be employed as a commercial truck driver with a route to and from Mexico City. The individual may then train as a truck driver until he receives an official certification of driver ability from the Department of Motor Vehicles or other institution responsible for determining driver privileges. The official certification of driver ability is converted into a travel privilege certificate with the type field set to ‘operator’ and is downloaded to the BPID 100 using the methods described above.

A significant benefit of incorporating vehicle operator privileges into the BPID 100 is that, with limited additional equipment, the operator can be authenticated to the vehicle and/or a monitoring institution at all times during vehicle operation. Following the example above, individual may be authorized to drive a truck carrying hazardous materials. With recent concerns about domestic terrorism, the trucking company wishes to ensure the identity of the driver while he is en route to verify that the truck has not been hijacked.

The trucking company has multiple options. The first option is to add a long-range transponder to the vehicle; many trucks are already equipped with such radios. The transponder can be adapted to interface to the BPID 100, such that the BPID 100 may transmit data to the transponder (two-way communication is optional). The BPID 100 with the travel application may transmit the vehicle operator's travel privilege certificate to the transponder, which can then in turn transmit the certificate to the trucking company, travel-governing institution, or other appropriate party. Because the travel privilege certificate transmission function can be configured to require user authentication, recipients of the certificates can be guaranteed that the legitimate device owner authorized transmission using the fingerprint.

The trucking company may alternatively add an intelligent kill switch to the truck. This kill switch is also configured to receive travel privilege certificates from the BPID 100. If the kill switch determines that an invalid certificate was received, or that no certificate at all was received, it can safely disable operation of the truck. One optimal embodiment of the invention incorporates the kill switch mechanism into the transponder. This allows the trucking company, travel-governing institution, etc., to monitor the driver's privileges and send the signal to terminate operation of the vehicle.

As described above, one significant part of enabling this monitoring system is to require transmission of travel privilege certificates while the vehicle is in operation. The trucking company, travel-governing institution, or other appropriate party may establish rules stating when the individual must transmit the certificate. For example, the driver may be required to send the certificate at regular time intervals, such as every half hour. Alternatively, he may be prompted to authenticate at random time intervals, for more security. The system can also be similarly configured to authenticate the user at regular or random mileage intervals.

To better enable this vehicle operator monitoring system, this invention creates a docking apparatus to securely hold a personal identification device, such as a BPID 100, while a vehicle is in motion. This apparatus may be seen in FIG. 6. The docking apparatus is established in such a manner that it places the BPID 100 in an orientation that allows the user to authenticate safely and easily, with minimal distraction during vehicle operation. The apparatus comprises a data jack connector 601, a power jack connector 602, and a cradle 603 that holds the BPID 100. The data jack 601 can be used to relay data from the BPID 100 to the vehicle, transponder, or other device. The power jack connector 602 overrides the BPID's 100 power supply, and allows the device to run off of battery power. The cradle 603, as described, holds the device, and may be placed in a variety of locations, such as a gearshift lever, steering apparatus, transponder or handbrake.

While the description above refers to particular embodiments of the present invention, it will be understood that many modifications may be made without departing from the spirit thereof. The accompanying claims are intended to cover such modifications as would fall within the true scope and spirit of the present invention.

We claim:

1. A system for ensuring the identity and travel privileges of potential travelers, comprising:
a. at least one institution for researching and recording an identity and at least one travel privilege for individuals;
b. at least one database maintained by the institution for associating identified individuals' names, an assigned asymmetric key pair, and the at least one travel privilege, said at least one travel privilege including:
i. at least one destination restriction;
ii. at least one date and time restriction;
iii. at least one mode of transportation restriction;
iv. at least one operator restriction; and
v. an expiration date for each at least one travel privilege;
c. at least one travel privilege certificate associated with the at least one travel privilege and further associated with an identified individual; and
d. at least one personal identification device including a means for enrolling and authenticating individuals and managing travel privilege certificates.

2. The system described in claim 1, wherein the travel privilege certificate comprises:
a. a name field, comprising the identified individual's full name;
b. a date field, comprising a date when the identified individual is allowed to travel;
c. a time field, comprising a time when the identified individual is allowed to travel;
d. a mode of transportation field, comprising a list of the modes of transportation that the identified individual is allowed to employ;
e. a type of privilege field, comprising the type of privilege signified by the travel privilege certificate;
f. an issue date field, comprising the date when the travel privilege certificate is issued;
g. an expiration date field, comprising the date when the travel privilege certificate is no longer valid;
h. a unique serial number; and
i. a digital signature created by the issuer of the travel privilege certificate.

3. The system described in claim 2 wherein the list of the modes of transportation includes at least one mode selected from the group consisting of a train, a bus, a car, an airplane and a ship.

4. The system described in claim 2 wherein the type of privilege is selected from the group consisting of a reservation ticket, a boarding pass, a port-of-entry permission and a vehicle operator permission.

5. The system described in claim 1 wherein the database is formed by completing the following steps for each individual:
a. collecting a digital representation of the individual's handwritten signature;
b. collecting a digital photograph of the individual's face;
c. collecting a digital fingerprint template of the individual's fingerprint;
d. collecting personal identification credentials from the individual, including a birth certificate and a social security number;
e. verifying the identity of the individual by the following steps:
i. submitting the collected digital fingerprint template to the Federal Department of Criminal Justice database for review;
ii. submitting the collected birth certificate to the National Association of Public Health Services Information System database for review;
iii. submitting the collected social security number to the social security number database for review;
iv. submitting the individual's name and the collected social security number to the Immigration and Naturalization Service database for review;
v. submitting the individual's name and the collected digital photograph to a database of already-enrolled individuals' names and photographs for review;
j. determining if the individual is authorized to travel;
k. determining authorized destinations for the individual;
l. determining authorized travel times and durations for the individual;
m. determining authorized modes of transportation for the individual;
n. creating a digital certificate and an asymmetric key pair for the individual; and
o. adding the individual's name, the collected digital photograph, public key, a date-of-validity, and the determined privileges to the database of already-enrolled individuals.

6. The system described in claim 1 wherein the means for enrolling and authenticating individuals and managing travel privilege certificates, comprises:
a. first download means for downloading at least one travel privilege certificate to said personal identification device;
b. transmission means for transmitting at least one travel privilege certificate from said personal identification device;
c. recording means for recording at least one notable event on said personal identification device;
d. first storage means for storing at least one travel privilege certificate on said personal identification device; and
e. second storage means for storing at least one application audit log on said personal identification device.

7. The system described in claim 6, further comprising:
a. verification means for verifying an individual's personal identity prior to issuing the travel privilege certificate;
b. second download means for downloading a computing mechanism onto the personal identification device; and
c. third download means for downloading a digital certificate and asymmetric key pair for the individual into the personal identification device.

8. The system described in claim 6 wherein an individual's request to complete a travel-related action is evaluated and fulfilled by the following steps:
a. authenticating the individual to the personal identification apparatus;
b. verifying the date-of-validity of a stored digital certificate;
c. accessing a database of enrolled individuals, associated privileges, and public keys, and verifying the individual's ownership of the private key;
d. viewing the individual's assigned privileges in the database;
e. determining if the individual has at least one of any pre-existing notations, restrictions and provisos preventing the requested action;
f. determining additional, action-specific notations, restrictions and provisos;
g. creating a travel privilege certificate;
h. receiving the travel privilege certificate; and
i. storing the travel privilege certificate.

9. The system described in claim 6 wherein the at least one travel privilege certificate is transmitted by the following steps:
a. authenticating the individual to the personal identification apparatus;
b. verifying the date-of-validity of a stored digital certificate;
c. accessing a database of enrolled individuals, associated privileges, and public keys, and verifying the individual's ownership of the private key;
d. selecting the at least one travel privilege certificate for transmission;
e. digitally signing the at least one travel privilege certificate with a stored private key; and
f. transmitting the signed travel privilege certificate.

10. The system described in claim 2 wherein the mode of transportation is a motor vehicle operated by the individual and further comprising a means for verifying the individual's motor vehicle operator privileges during vehicle operation.

11. The system described in claim 10 wherein the individual's motor vehicle operator privileges are verified at regular and pre-defined time intervals.

12. The system described in claim 10 wherein the individual's motor vehicle operator privileges are verified at random time intervals.

13. The system described in claim 10 wherein the individual's motor vehicle operator privileges are verified at regular and pre-defined mileage intervals.

14. The system described in claim 10 wherein the individual's motor vehicle operator privileges are verified at random mileage intervals.

15. The system described in claim 10 wherein the motor vehicle is disabled if verification is not achieved.

16. The system described in claim 10 wherein the means for verifying the individual's motor vehicle operator privileges during vehicle operation is a transponder located within the motor vehicle.

17. The system described in claim 16 wherein the transponder is connected to a local kill switch for disabling the vehicle, and receives messages from a remote institution for enabling said kill switch.

18. The system described in claim 10 further comprising:
a. a cradle for securing the personal identification device into a specific location within the motor vehicle;
b. an electrical power connector coupled to the cradle for supplying electric power to the personal identification device, further adapted to allow the personal identification device to be fully powered and to override existing battery power; and
c. a data link connector coupled to the electrical power connector, for relaying communications between the personal identification device and a vehicle-based transponder.

19. The system described in claim 18, wherein the cradle is secured to a motor vehicle element selected from the group consisting of a vehicle gearshift lever, a vehicle steering apparatus, a vehicle transponder and a vehicle handbrake apparatus.

20. A system for monitoring and verifying the identity of a traveling individual, comprising:
a means for collecting identification information for each traveling individual, wherein the collected identification information includes at least one biometric characteristic for the individual;
a means for verifying the collected identification information;
a means for determining at least one travel privilege for the traveling individual;
a means for creating an electronic travel privilege certificate based on the determined at least one travel privilege;
a personal identification device;
a means for transmitting the electronic travel privilege certificate to the personal identification device; and
a means for reading the electronic travel privilege certificate from the personal identification device as necessary during the traveling individual's travel.
